(19) United States
(12) Patent Application Publication
(10) Pub. No.: US 2012/0152399 A1
(43) Pub. Date: Jun. 21, 2012

(54) F.U.N tunnel(s)

(76) Inventors: Marc Gregory Allinson, Kingsville, MD (US); Phillip Royce Miller, Joppa, MD (US)

(21) Appl. No.: 13/200,282

(22) Filed: Sep. 22, 2011

Related U.S. Application Data
(60) Provisional application No. 61/459,866, filed on Dec. 20, 2010.

(51) Int. Cl. F16L 9/22

(52) U.S. Cl. 138/155

(57) ABSTRACT

A pipe of unique design capable of augmenting any flow, including but not limited to: gas, liquid, particulate, plasma, and/or other fluid state or any combination thereof whether the flow is human and/or naturally made such that the tunnel produces a net decrease in pressure and a net increase in speed of a flow. The tunnel(s) can be used to augment flow to, from, in, at, and/or around turbines and/or rotors.

### CROSS REFERENCE

This Invention, The F.U.N. Tunnel(s) claims the benefit of the filing date of provisional patent 61/459,866 with a US filing date of Dec. 20, 2010 and a foreign filing date of Jan. 21, 2011.

### DESCRIPTION

1. Technical Field

The present invention relates to venturi tunnel(s) used for a wide variety of industrial uses including but not limited to directing flows to, at, in, and/or around electricity producing turbines.

2. Background

The F.U.N. Tunnel(s) is a unique type of pipe(s). It utilizes a series of venturis to increase the speed and decrease the pressure of matter flowing over a distance. Both U.S. Pat. No. 4,690,245 and U.S. Pat. No. 4,936,413 claim the use of a series of venturis in automotive applications, however The F.U.N Tunnel(s) is materially different because the peak cross sectional areas of its chambers decrease from entrance chamber to middle chamber/chambers to exit chamber, whereas both U.S. Pat. No. 4,690,245 and U.S. Pat. No. 4,936,413 claim the benefit of a series of venturis with equal peak cross sectional across all chambers along the entire length of their claimed inventions. This difference is material because the peak cross sectional areas of the chambers must decrease to generate a net increase in speed and a net decrease in pressure in matter flowing over a distance. If the chambers are of the same peak cross sectional area, the flow will return to baseline pressure and speed, the same pressure and speed at the entrance of the tunnel(s).

Furthermore, U.S. Pat. No. 4,213,939 is a carbon black reactor that utilizes a series of venturis with varying peak cross sectional areas, however this invention is materially different from The F.U.N. Tunnel(s) because the peak cross sectional areas of the chambers increase from entrance chamber to middle chamber to exit chamber whereas the peak cross sectional areas of the chambers in The F.U.N Tunnel(s) decrease from entrance chamber to middle chamber(s) to exit chamber. The configuration of the venturis in U.S. Pat. No. 4,213,939 cause a net decrease in speed and a net increase in pressure, whereas the venturis in The F.U.N Tunnel(s) cause a net increase in speed and a net decrease in pressure of matter flowing over a distance. The F.U.N. Tunnel functions in the same way as a conventional venturi, however it can perform this function over a distance.

### BRIEF SUMMARY OF THE INVENTION

The F.U.N. Tunnel(s) is a pipe(s) designed to increase the speed and decrease the pressure of matter flowing over a distance.

### DESCRIPTION OF THE DRAWINGS

Note: Filled arrows mark direction of flow, and non-filled arrows mark dimension change.

FIG. 1A, 1B, and 1C: These pictures depict some of the possible shapes of The F.U.N. Tunnel(s) that adhere to the invention claims.

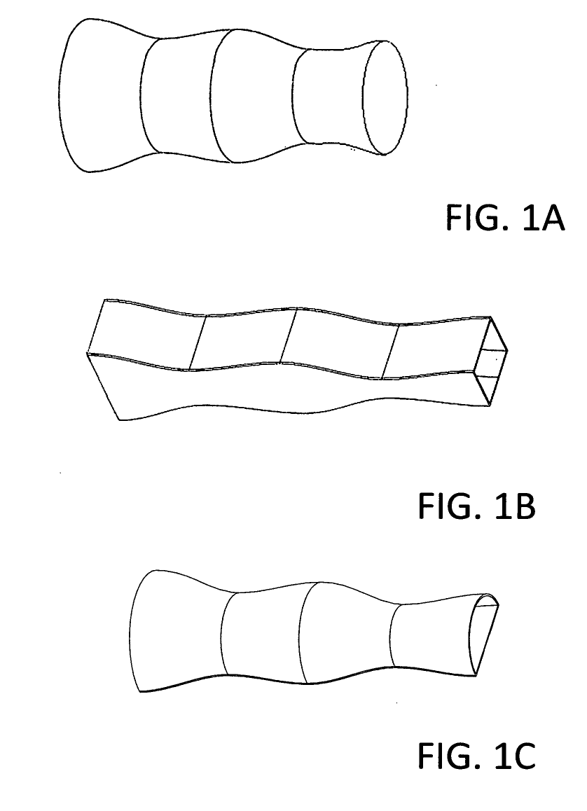

FIG. 2: This image depicts a cross sectional diagram of The F.U.N. Tunnel(s). 9 marks the first venturi in the series and 10 marks the second venturi in the series. The arrow depicts the direction of flow through the tunnel(s) which is implied thereafter in all the drawings.

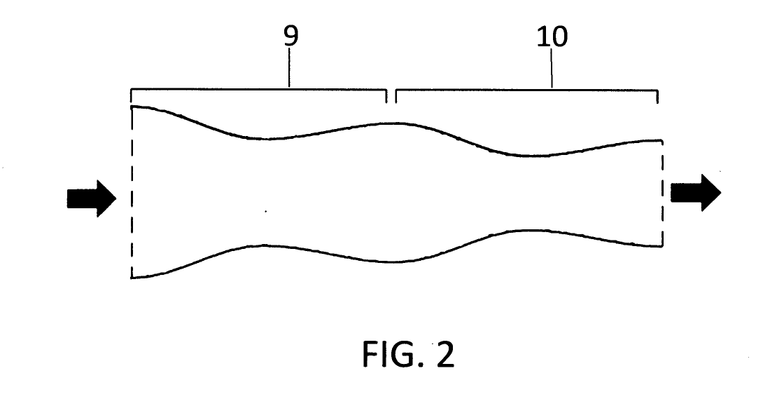

FIG. 3: This image depicts a cross sectional diagram of The F.U.N. Tunnel(s). 11, 12, and 13 mark a series of 3 venturis.

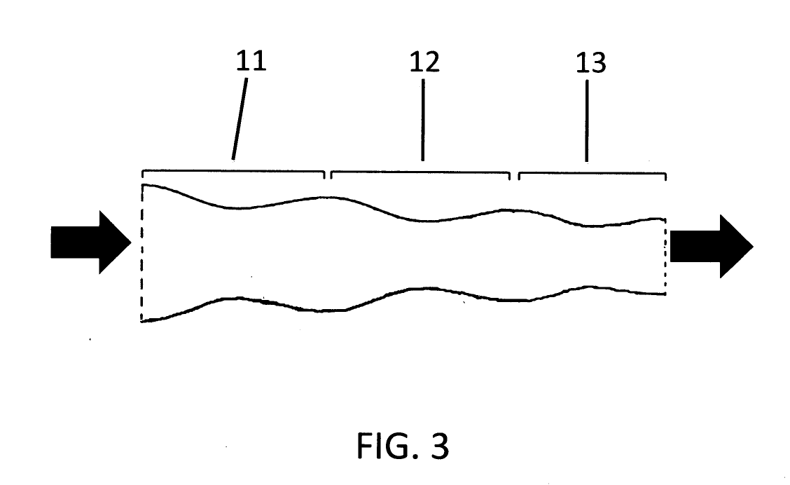

FIG. 4: This figure depicts a cross sectional diagram of The F.U.N. Tunnel(s). 14 marks the entrance chamber, 15 marks the middle chamber, 16 marks the exit chamber. 17 marks the point of peak cross sectional area of the entrance chamber, 18 marks the first constriction point, 19 marks the point of peak cross sectional area of the middle chamber, 20 marks the second constriction point, and 21 marks the point of peak cross sectional area of the exit chamber; note the decreasing peak cross sectional areas of the chambers. 22 marks the midline of the tunnel(s) which can change position and direction.

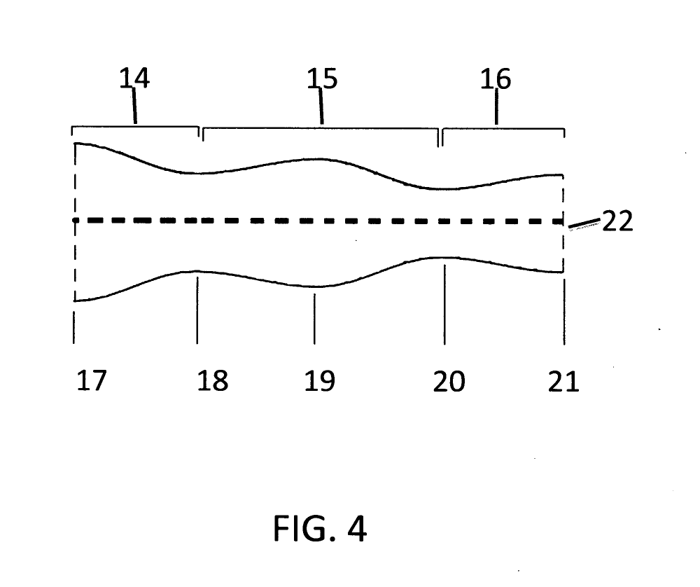

FIG. 5: FIGS. 5A, 5B, and 5C depict cross sectional diagrams of a single venturi system(s) placed around The F.U.N. Tunnel(s) as set forth in claim 5. Brackets used to attach tunnel(s) together are not shown in the drawing due to the view needed to understand the drawing.

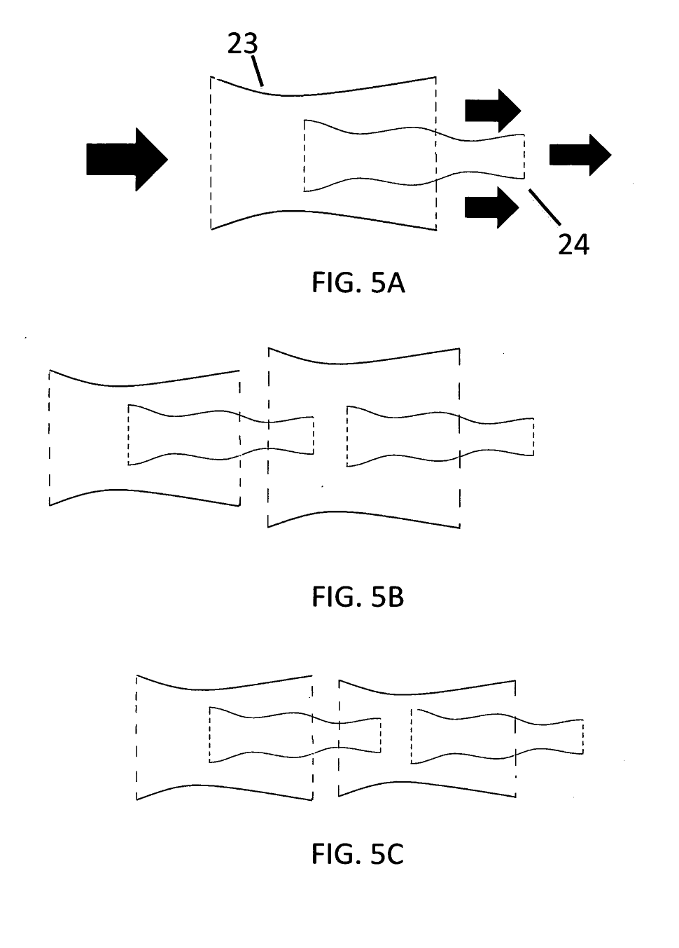

FIG. 6: This figure depicts a cross sectional diagram of two F.U.N. Tunnel(s) in an exit to entrance series; this configuration is possible due to the claims set forth in claims 5 and 6. Brackets used to attach tunnel(s) together are not shown in the drawing due to the required view.

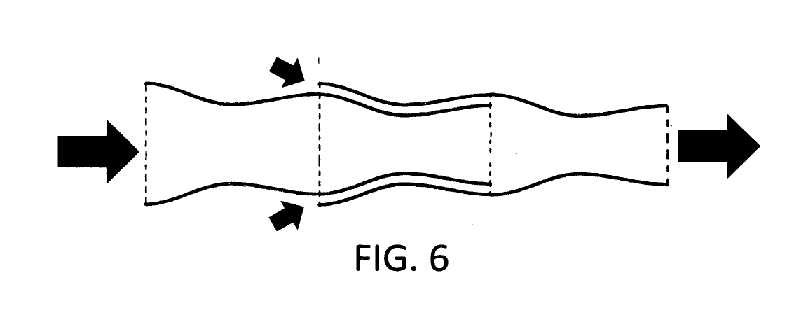

FIG. 7: This figure depicts a cross sectional diagram of three F.U.N. Tunnel(s) arranged in an exit to entrance series with a fourth F.U.N. Tunnel(s) placed around the exit to entrance series; this is possible due to the claims set forth in claims 5 and 6. Brackets used to attach tunnel(s) together are not shown in the drawing due to the required view.

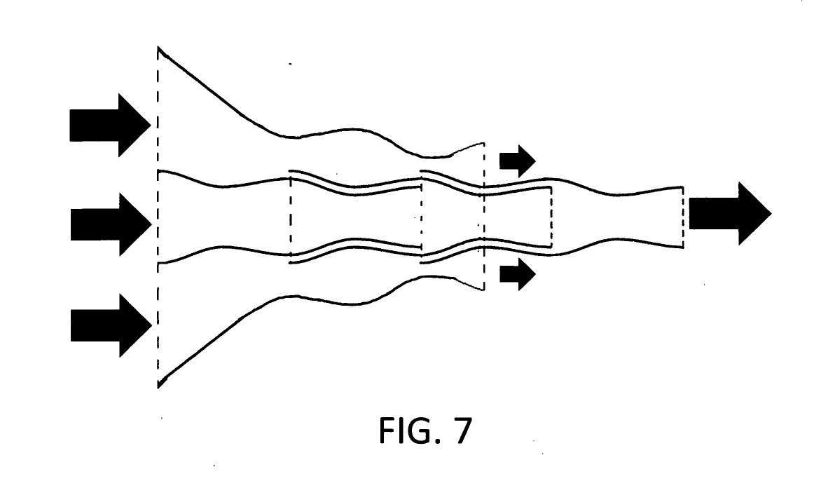

FIG. 8: This figure depicts a cross sectional diagram of The F.U.N. Tunnel(s).

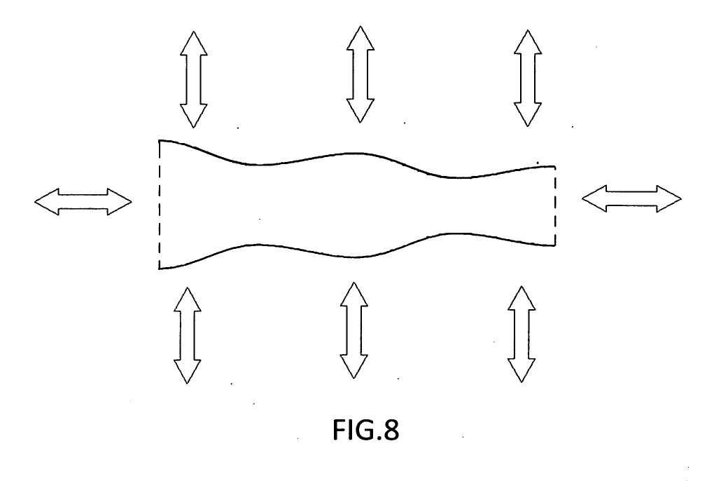

### DETAILED DESCRIPTION OF THE INVENTION

The F.U.N. Tunnel(s) is a system of pipe(s) used to augment flows. It is an open pipe(s) comprised of a converging entrance chamber, diverging then converging middle chamber(s), and a diverging exit chamber resulting in a pipe with multiple constriction points creating a series of venturis with peak cross sectional areas of the chambers decreasing from entrance chamber to middle chamber(s) to exit chamber, thus generating a net decrease in pressure and a net increase in speed of the matter flowing through the length of the invention, simply put the tunnel(s) generates an decrease of pressure and an increase of speed in matter flowing over a distance. This is accomplished because the pressure at the entrance of a venturi is lower than the pressure at the entrance of a previous venturi along the length of the invention. The F.U.N. Tunnel can be used throughout industry wherever a flow is present. Some of the industrial uses include nozzles, particle accelerators, turbine ducts, and stents.

1: The F.U.N. Tunnel(s), for the purpose of these claims referred to as tunnel(s), is used to augment the properties of any flow, including but not limited to: gas, liquid, steam, water, particulate, plasma, and/or other fluid state or any combination thereof whether the flow is human and/or naturally made for a multitude of industrial uses including but not limited to facilitating the generation of electrical power, acting as a turbine duct, directing a flow towards a turbine, directing a flow away from a turbine, transporting flows, and/or being used as a nozzle; it is an open pipe(s) comprised of a converging entrance chamber, diverging then converging middle chamber(s), and a diverging exit chamber resulting in a pipe(s) with multiple constriction points creating a series of venturis with peak cross sectional areas of the chambers decreasing from entrance chamber to middle chamber(s) to exit chamber, thus creating a net decrease of pressure and a net increase of speed in the matter flowing throughout the length of the pipe(s), furthermore the position of the points of peak cross sectional areas can change position along the length of the tunnel(s) as can the length of venturis in the series, as can the lengths of the chambers, as can the cross sectional shapes of the tunnel(s), so long as the tunnel(s) walls maintain the converging and diverging angles such that the pressure at the point that one venturi ends and another begins in the series is lower than the tunnel(s) entrance pressure and/or the beginning of the previous venturi; the purpose of this configuration is to decrease the pressure and increase the speed matter flowing over a distance.

2: As to the tunnel set forth in claim 1, any chamber may diverge to the point or past the point of the established baseline entrance pressure of the flow; furthermore a diffuser can be placed at the exit of tunnel(s) to increase the pressure and the speed of the flow.

4: As to the tunnel set forth in claim 1, the midline of the tunnel(s) can but does not have to remain straight, allowing the tunnel(s) augment flow in a desired direction(s).

5: As to the tunnel(s) set forth in claim 1, the tunnel(s), single venturi system(s), and/or smooth pipe(s) can be placed inside a tunnel(s) into the entrance and/or exit and/or around the entrance and/or exit of another tunnel(s) before, after, or at the entrance and/or exit, and/or any of the constriction points, or any position along the length of the tunnel(s), and this can be repeated, multiple times separately or in a series.

6: As to the tunnel(s) set forth in claim 1, the exit of one tunnel can be placed inside the entrance of another tunnel past the first constriction point creating an exit to entrance series, and this can be repeated with or without additional tunnel(s), funnels, smooth pipes, and/or single venturi(s) systems placed inside, before, at, after, and or around the aforementioned tunnels, which also can be repeated, and this can be used as but not limited to a nozzle, pipeline, and/or can be used to facilitate the generation of electricity or motion by directing any flow, including by not limited to a water current, wind current, exhaust current, combustion, and/or steam current to be used to spin a rotor; as this configuration performs the exact same function as a single tunnel, increasing the speed of a flow while decreasing the pressure of matter flowing over a distance, it thus can be used for the exact same industrial uses as a single tunnel and is the same device.

7: The tunnel(s) of claim 1 can be used to augment the flow in pipelines including but not limited to pipelines moving natural gas, oil, petroleum products, bio-fuels, water, liquid chemicals, and or vapors.

8: The tunnel(s) of claim 1 can be used to augment the flows needed to propel projectiles.

9: The tunnel(s) of claim 1 can be used to augment the flows present in propulsion systems including but not limited to flows around, to, and/or from propellers.

10: The tunnel(s) of claim 1 can act as a combustion chamber and/or be used to transport flows to, around, in and/or from combustion engines.

11: The tunnel(s) of claim 1 can be composed of any material, including but not limited to:
polymer, metal, mineral, composite, carbon, fibrous.

12: To help reduce the impact of the dissipating forces the tunnel(s) of claim 1 can be coated with any form of friction reducing material including but not limited to ultra-low wear carbon coatings, polyethylene, and/or fluoropolymers.

13: The tunnel(s) of claim 1 can be infused with magnets at any point along the tunnel(s), and/or the tunnel(s) can be composed from a magnetic field.

14: The tunnel(s) of claim 1 can be used as a duct for a turbine and/or to augment flows towards and/or away from a turbine, rotor, and/or generator whether the flow is a water current, steam current, wind current, gas current, and/or exhaust current whether the flow is naturally and/or human generated.

15: Devices needed to generate electricity can be used in combination with the tunnel(s) of claim 1; this includes but is not limited to brackets to attach multiple tunnel(s)s together, brackets to attach tunnels to other fixtures, brackets to attach fixtures to the tunnel(s), pumps, inlet valves, outlet valves, grates, anodes, cathodes, hinges, filters, turbines spun by drag, turbines spun by opposing lift along a central axis, coils, permanent magnets, fins, funnels, brushes, field coils/electromagnets, bearings, capacitors, batteries, wires, stators, armatures, commutators, and/or governors.

16: The tunnel(s) of claim 1 can be used as, in, around, before, and/or after jets, fans, ventilation, blowers, and/or pumps.

17: The tunnel(s) of claim 1 can be used as, in, around, before, and/or after fuel injectors.

18: The tunnel(s) of claim 1 can be used as, in, around, before, and/or after blast furnaces.

19: The tunnel(s) of claim 1 can be used as, in, around, before, and/or after a nozzle.

20: The tunnel(s) of claim 1 can be used to augment the flows of human produced waste exhaust, circulation systems, and/or ventilation systems.

21: The thickness of the walls throughout the tunnel(s) of claim 1 can change, including but not limited to tapering the entrance and/or the exit walls of the tunnel(s).

22: Any device and/or fixture including but not limited to: mechanical, electrical, magnetic, thermal, nuclear, and/or chemical devices/fixtures can be placed and/or attached around, to, near, and/or in the tunnel(s) and/or in any position in relation to the tunnel(s) of claim 1.

23: The tunnel(s) of claim 1 can be used to augment flows to, from, at, in, through, around, and in any direction and/or position in relation to and/or function as and/or be integrated into and/or to facilitate and/or be incorporated into the design of in any way of the following but not limited to: rivers, water channels, reservoirs, lakes, levies, dams, dykes, ocean currents, wind current, water current, steam flow, exhaust, indoor and outdoor plumbing, irrigation, existing hydro electric facilities, drainage ditches, smoke stacks, steam stacks, flues, fans, blowers, pumps, compressors, combustion engines, accelerating projectiles, pipelines, tubing, steam turbine generators, hydroelectric generators, wind electric energy generators, liquid jets, gas jets, plasma jets, blast forges, shower head, transportation vehicles, house hold appliances, freezers, convection ovens, kilns, fuel injectors, combustion engines, sewage systems, drainage, ventilation, papermaking, defoaming system, human/industrial waste, heating, air conditioning, circulation systems, nozzles, coolant systems, mining, funnel, squirt gun, stent, keel, gutter, hair drier, filtration, water runoff, spigots, sprinklers, fountains, public/private water systems, spouts, sprayers, musical instruments, water mains, water towers, marine vessels, flood control, respirators, inhalers, smoking paraphernalia, oil/natural gas wells, filtration, eductors, inspirators, aspirators, siphons, Atomizers, Carburetors, kitchen appliances, wine aerators, protein skimmers, vacuum generators, vacuum cleaners, venturi scrubbers, turbines, propellers, injectors, ejectors, steam injectors, steam ejectors, sand blasters, bilge emptying system, scuba diving regulator, vaporizers, medical applications, oxygen masks, centrifuge, geo-thermal heating/cooling systems, wells, storage containers, venturi masks, magnetic nozzles, propulsion systems, to spin a turbine/generator, to move fluids, to facilitate/provide flow, and any human or naturally generated/augments flows and/or industrial products with single venturi tunnel applications.

24: The tunnel(s) of claim 1 can have perforations and/or augmentations to the surfaces of the tunnel including but not limited to inlet and outlet valves at any position along the tunnel(s).
